(19) United States
(12) Patent Application Publication
(10) Pub. No.: US 2026/0025249 A1
(43) Pub. Date: Jan. 22, 2026

(54) PHYSICAL DOWNLINK CONTROL CHANNEL (PDCCH) RESOURCE ALLOCATION FOR SUB-BAND BASED FULL DUPLEX OPERATION

(71) Applicant: Lenovo (Singapore) Pte. Limited, Singapore (SG)

(72) Inventors: Hyejung Jung, Northbrook, IL (US); Hossein Bagheri, Dearborn Heights, MI (US); Vijay Nangia, Woodridge, IL (US)

(21) Appl. No.: 19/099,737

(22) PCT Filed: Jul. 27, 2023
(86) PCT No.: PCT/IB2023/057639

§ 371 Date: Jan. 29, 2025

Related U.S. Application Data
(60) Provisional application No. 63/369,925, filed on Jul. 29, 2022.

(51) Int. Cl. H04L 5/00; H04L 5/14

(52) U.S. Cl. CPC H04L 5/0053; H04L 5/14

(57) ABSTRACT

Various aspects of the present disclosure relate to a user equipment (UE), a base station, and methods that provide wireless communication in a full duplex bandwidth part. The UE includes a memory and a processor communicatively coupled to the memory and configured to cause the UE to receive a control resource set (CORESET) configuration that includes information of resource block (RB) offset(s) and of RBs allocated to a CORESET. Each RB offset corresponds to a respective subset of groups of a first number of RBs from among a larger set of groups of the first number of RBs of a downlink (DL) bandwidth part (BWP). The processor is further configured to cause the UE to receive a physical downlink control channel (PDCCH) based on the plurality of RBs allocated to the CORESET and to receive the PDCCH based on the plurality of RBs allocated to the CORESET.

### PRIORITY APPLICATION

This application claims priority to U.S. Application No. 63/369,925 filed Jul. 29, 2022, the content of which is fully incorporated herein.

### TECHNICAL FIELD

The present disclosure relates to wireless communications, and more specifically to wireless communications that supports Physical Downlink Control Channel (PDCCH) resource allocation for sub-band based full duplex operation.

### BACKGROUND

A wireless communications system may include one or multiple network communication devices, including base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, and other suitable radio access technologies beyond 5G.

In unpaired spectrum, time division duplex (TDD) is used to avoid interference, such as uplink and downlink interference within a network entity and user equipment (UE)-to-UE interference. However, TDD limits uplink (UL) and downlink (DL) transmission opportunities and poses difficulties to accommodate urgent UL and DL transmissions simultaneously, especially when DL and UL traffics are asymmetric in a cell. When a network entity (e.g., gNB) is capable of frequency division duplexing (FDD) with simultaneous reception and transmission with a certain level of self-interference suppression, the network entity can reduce latency by allowing controlled UL/DL transmissions while on-going DL/UL traffic is served in a carrier. The network entity can configure a first sub-band of a carrier as an UL resource and a second sub-band of the carrier, not overlapping with the first sub-band, as a DL resource for full duplex cell operation within the carrier, at least for a certain duration.

### SUMMARY

The present disclosure relates to methods, apparatuses, and systems, which provide wireless communication that ease interference handling, such as self-interference and cross-link interference. In an example, the interference is between user equipment (“UEs”) or between base stations. In particular, the present disclosure addresses sub-band based full duplex operation. In particular, one sub-band of a carrier serving uplink (UL) traffic and another sub-band of the carrier serving downlink (DL) traffic in unpaired spectrum can be considered. The present disclosure provides enhanced resource allocation in symbols configured with full duplex sub-bands used for sub-band based full duplex operation.

Some implementations of the method and apparatuses described herein may include supporting wireless communication by a user device. The method includes receiving, via a transceiver of the user device, a control resource set (CORESET) configuration comprising information of at least one resource block (RB) offset and of a plurality of RBs allocated to a CORESET. Each of the at least one RB offset corresponds to a respective subset of groups of a first number of RBs from among a larger set of groups of the first number of RBs of a downlink (DL) bandwidth part (BWP). The method includes configuring the user device to receive a physical downlink control channel (PDCCH) based on the plurality of RBs allocated to the CORESET. The method includes receiving the PDCCH based on the plurality of RBs allocated to the CORESET.

Some implementations of the method and apparatuses described herein may support wireless communication by a Network Entity (NE). The method includes transmitting a CORESET configuration comprising information of at least one RB offset, each of the at least one RB offset corresponding to a respective subset of groups of first number of RBs of a set of groups of first number of RBs of a DL BWP. The method includes allocating a plurality of RBs to the CORESET based on the CORESET configuration. The method includes transmitting a physical downlink control channel (PDCCH) based on the plurality of RBs allocated to the CORESET according to the at least one RB offset.

### BRIEF DESCRIPTION OF THE DRAWINGS

FIG. 1 illustrates an example of a wireless communications system enabling wireless communication that supports PDCCH resource allocation for sub-band based full duplex operation, in accordance with aspects of the present disclosure.

FIG. 2 presents a communication environment of a downlink (DL) and an uplink (UL), in accordance with aspects of the present disclosure.

FIG. 3 presents exemplary six (6) RB group (RBG) configurations for frequency domain resource allocation of a CORESET, when a full duplex UL sub-band is configured within a DL BWP for sub-band based full duplex operation, in accordance with aspects of the present disclosure.

FIG. 4 presents exemplary RBG configurations for frequency domain resource allocation of a CORESET, when a full duplex UL sub-band is configured within a DL BWP for sub-band based full duplex operation, in accordance with aspects of the present disclosure.

FIG. 5 depicts an exemplary “ControlResourceSet” information element (IE) that is used to configure a time/frequency CORESET in which to search for downlink control information, in accordance with aspects of the present disclosure.

FIG. 6 illustrates an example of a block diagram of a user device that supports PDCCH resource allocation for sub-band based full duplex operation, in accordance with aspects of the present disclosure.

FIG. 7 illustrates an example of a block diagram of a network device that supports PDCCH resource allocation for sub-band based full duplex operation, in accordance with aspects of the present disclosure.

FIG. 8 illustrates a flowchart of a method performed by a user device that supports wireless communication of PDCCH resource allocation for sub-band based full duplex operation, in accordance with aspects of the present disclosure.

FIG. 9 illustrates a flowchart of a method performed by a network device that supports wireless communication of PDCCH resource allocation for sub-band based full duplex operation, in accordance with aspects of the present disclosure.

### DETAILED DESCRIPTION

In 3GPP New Radio (NR), a physical downlink control channel (PDCCH) consists of one or more control-channel elements (CCEs), e.g., 1, 2, 4, 8, 16 CCEs. A CCE consists of 6 resource-element groups (REGs), where a REG equals one resource block during one Orthogonal Frequency-Division Multiplexing (OFDM) symbol. A control-resource set (CORESET) consists of

$${N}_{RB}^{CORESET}$$

resource blocks in the frequency domain and

$${N}_{symb}^{CORESET}$$

∈{1,2,3} in the time domain. REGs within a CORESET are numbered in increasing order in a time-first manner, starting with 0 for the first OFDM symbol and the lowest-numbered resource block in the CORESET. Each CORESET is associated with one CCE-to-REG mapping.

As currently provided, a CCE-to-REG mapping for a CORESET can be interleaved or non-interleaved and is described by REG bundles:
(i) REG bundle i is defined as REGs {iL, iL+1, . . . , iL+L−1} where L is the REG bundle size,

$$i = 0 , 1 , … , {N}_{REG}^{CORESET} / L - 1 , and {N}_{REG}^{CORESET} = {N}_{RB}^{CORESET} {N}_{symb}^{CORESET}$$

is the number of REGs in the CORESET; and
(ii) CCE j consists of REG bundles {f(6j/L), f(6j/L+1), . . . , f(6j/L+6/L−1)} where f(⋅) is an interleaver.

For non-interleaved CCE-to-REG mapping, L=6 and f(x)=x. For interleaved CCE-to-REG mapping, L∈{2,6} for

$${N}_{symb}^{CORESET} = 1$$

### and L∈

$$\{ {N}_{symb}^{CORESET} , 6 \}$$

for

$${N}_{symb}^{CORESET}$$

∈{2,3}. The interleaver is defined by:

$$f ( x ) = ( rC + c + {n}_{shift} ) mod ( {N}_{REG}^{CORESET} / L ) \\ x = cR + r \\ r = 0 , 1 , … , R - 1 \\ c = 0 , 1 , … , C - 1 \\ C = {N}_{REG}^{CORESET} / ( LR )$$

where R∈{2,3,6}. The UE is not expected to handle configurations resulting in the quantity C not being an integer.

For a CORESET configured by the “ControlResourceSet” Information Element (IE):

$$( i ) {N}_{RB}^{CORESET}$$

is given by the higher-layer parameter frequencyDomainResources;

$$( ii ) {N}_{symb}^{CORESET}$$

is given by the higher-layer parameter duration, where

$${N}_{symb}^{CORESET} = 3$$

is supported only is the higher-layer parameter dmrs-TypeA-Position equals 3;
(iii) interleaved or non-interleaved mapping is given by the higher-layer parameter cce-REG-MappingType;
(iv) L equals 6 for non-interleaved mapping and is given by the higher-layer parameter reg-BundleSize for interleaved mapping;
(v) R is given by the higher-layer parameter interleaverSize;
(vi) n_{shift}∈{0, 1, . . . , 274} is given by the higher-layer parameter shiftIndex if provided, otherwise

$${n}_{shift} = {N}_{ID}^{cell} ;$$

(vii) for both interleaved and non-interleaved mapping, the UE may assume the same precoding being used within a REG bundle, if the higher-layer parameter precoderGranularity equals sameAsREG-bundle. The UE may also assume the same precoding is being used across the all resource-element groups within the set of contiguous resource blocks in the CORESET. In addition, the UE may assume that no resource elements in the CORESET overlap with a synchronization signal block (SSB) or LTE cell-specific reference signals as indicated by the higher-layer parameter Ite-CRS-ToMatchAround, Ite-CRS-PatternList1, or Ite-CRS-PatternList2, if the higher-layer parameter precoderGranularity equals allContiguousRBs.

As currently provided, ‘point A’ serving as a common reference point for resource block grids is obtained from:
(i) offsetToPointA for a primary cell (PCell) downlink, where offsetToPointA represents the frequency offset between ‘point A’ and the lowest subcarrier of the lowest resource block, which overlaps with the SS/PBCH block used by a UE for initial cell selection, expressed in units of resource blocks, assuming 15 kHz subcarrier spacing for frequency range 1 (FR1, e.g., 410 MHz-7125 MHz) and 60 kHz subcarrier spacing for frequency range 2 (FR2, e.g., 24250 MHz-52600 MHZ);
(ii) absoluteFrequencyPointA for all other cases, where absoluteFrequencyPointA represents the frequency-location of ‘point A’ expressed as in Absolute Radio Frequency Channel Number (ARFCN).

As currently provided, common resource blocks are numbered from 0 and upwards in the frequency domain for subcarrier spacing configuration μ, where subcarrier spacing is given by Δf=2^{μ}·15 [kHz]. The center of subcarrier 0 of common resource block 0 for subcarrier spacing configuration μ coincides with ‘point A’. The relation between the common resource block number

$${n}_{CRB}^{μ}$$

in the frequency domain and resource elements (k, l) for subcarrier spacing configuration μ is given by:

$${n}_{CRB}^{μ} = ⌊ \frac{k}{{N}_{sc}^{PB}} ⌋ ,$$

where k is defined relative to point A such that k=0 corresponds to the subcarrier centered around ‘point A’.

To ease interference handling such as self-interference and cross-link interference (e.g., UE-to-UE, base station (BS)-to-BS), sub-band based full duplex operation (i.e., one sub-band of a carrier serves UL traffics and another sub-band of the carrier serves DL traffics) in unpaired spectrum can be considered. The present disclosure provides enhanced resource allocation in symbols configured with full duplex sub-bands that gNB would use for sub-band based full duplex operation.

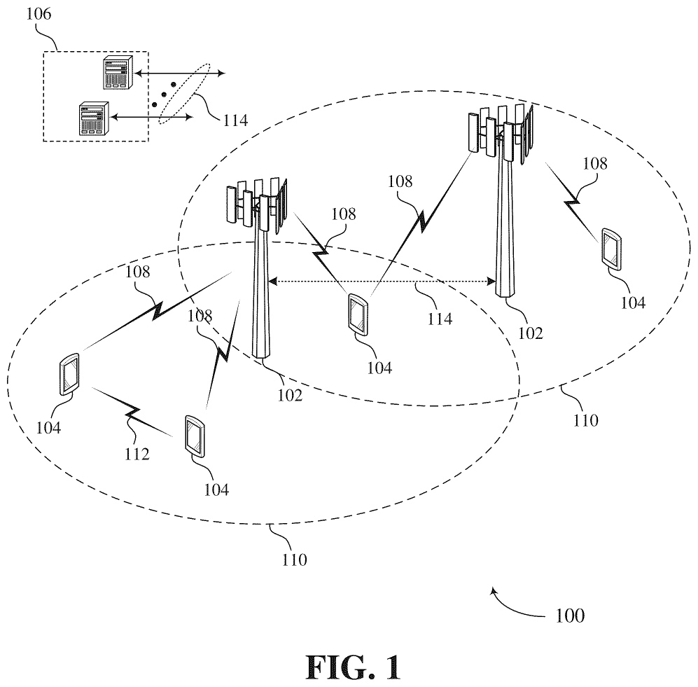

FIG. 1 illustrates an example of a wireless communications system 100 enabling wireless communication that supports PDCCH resource allocation for sub-band based full duplex operation, in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a New Radio (NR) network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, may include, or may be referred to as a base transceiver station, an access point, a NodeB, an eNodeB (eNB), a next-generation NodeB (gNB), a network device, or other suitable terminology. A base station 102 and a UE 104 may communicate via a communication link 108, which may be a wireless or wired connection. For example, a base station 102 and a UE 104 may wirelessly communicate over a user to user (Uu) interface.

A base station 102 may provide a geographic coverage area 110 for which the base station 102 may support services (e.g., voice, video, packet data, messaging, broadcast, etc.) for one or more UEs 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, for example, a satellite associated with a non-terrestrial network. In some implementations, different geographic coverage areas 110 associated with the same or different radio access technologies may overlap, but the different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or devices having different capabilities. Some examples of UEs 104 are illustrated in FIG. 1. A UE 104 may be capable of communicating with various types of devices, such as the base stations 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102 or UEs 104, which may act as relays in the wireless communications system 100.

In the description that follows, the timing of transmissions and retransmissions of control channels and data channels supports latency and/or error rate requirements for portions of video frames and may be referred to as time units. Time units, such as a symbol, slot, subslot, and transmission time interval (TTI), can have a particular duration. In an example, a symbol could be a fraction or percentage of an orthogonal frequency division multiplexing (OFDM) symbol length associated with a particular subcarrier spacing (SCS). In another example, an uplink (UL) transmission burst can be comprised of multiple transmissions. The multiple transmission can have the same priority, different priorities, or may have no associated priority. The multiple transmissions may include gaps between the transmissions that are short enough in duration to not necessitate performing a channel sensing or listen before transmit (LBT) operation between the transmissions.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface. PC5 refers to a reference point where the UE 104 directly communicates with another UE 104 over a direct channel without requiring communication with the base station 102.

A base station 102 may support communications with the core network 106, or with another base station 102, or both. For example, a base station 102 may interface with the core network 106 through one or more backhaul links 114 (e.g., via an S1, N2, or another network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

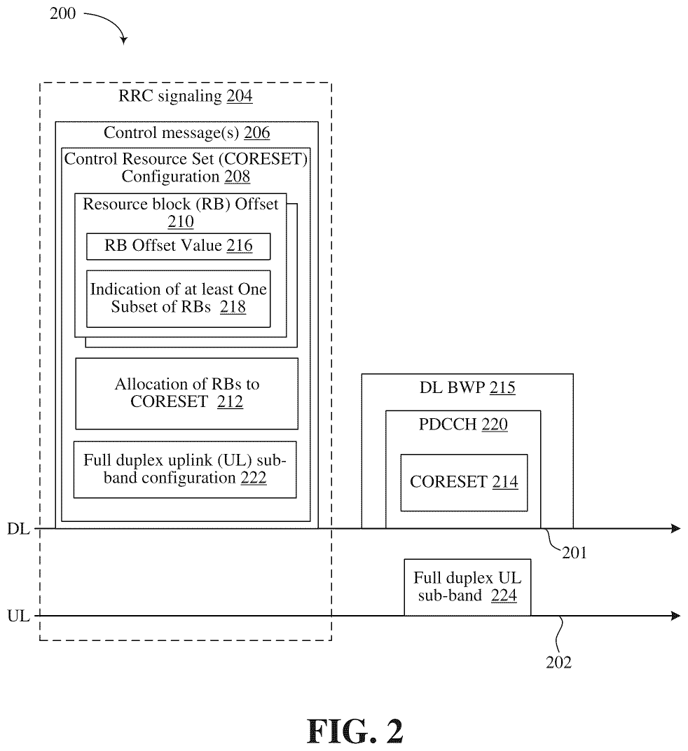

FIG. 2 presents a communication environment 200 of a downlink (DL) 201 transmitted by a network device such as the base station 102 (FIG. 1) and an uplink (UL) 202 transmitted by a user device 104 (FIG. 1). Radio resource control (RRC) signaling 204 on both DL 201 and UL 202 include one or more control messages 206 on the DL 201 that contain CORESET configuration 208. The CORESET configuration 208 includes information of at least one resource block (RB) offset 210 and an allocation of a plurality of RBs 212 to a CORESET 214. Each of the at least one RB offset 210 correspond to a respective subset of groups of a first number of RBs from among a larger set of groups of the first number of RBs of a DL BWP 215. The at least one RB offset 210 includes at least one RB offset value 216 and an indication of at least one subset of groups 218 of the first number of RBs corresponding to the at least one RB offset value. The CORESET configuration 208 configures the user device 104 (FIG. 1) to receive a PDCCH 220 based on the plurality of RBs allocated to the CORESET 214. In one or more embodiments, the CORESET configuration 208 includes full duplex UL sub-band configuration 222 that configures the user device 104 (FIG. 1) to transmit on a full duplex UL sub-band 224 of the UL 202. A bandwidth of the full duplex UL sub-band 224 overlaps in frequency with a bandwidth of the DL BWP 215.

When a network entity (e.g., gNB) is capable of simultaneous reception and transmission (i.e., capable of full duplexing with a certain level of self-interference suppression) within a carrier, the network entity can configure a first sub-band of a carrier as an UL resource and a second sub-band of the carrier not overlapping with the first sub-band as a DL resource for full duplex cell operation within the carrier, at least for a certain duration. In some examples, the first sub-band and the second sub-band may at least partially overlap.

In an implementation, a UE receives information of a time and frequency resource (i.e. full duplex UL sub-band) for UL transmission on at least some symbols configured as DL or flexible symbols and/or a time and frequency resource (i.e. full duplex DL sub-band) for DL reception on at least some symbols configured as UL or flexible symbols, where the configuration of symbols as DL, UL, or flexible symbols is provided by “tdd-UL-DL-ConfigurationCommon” and additionally by “tdd-UL-DL-Configuration Dedicated”, if configured. The information of full duplex UL sub-band and/or full duplex DL sub-band may be signaled as part of system information in a system information block (SIB) and/or in a dedicated RRC message.

PDCCH resource allocation with sub-band full duplex operation: In one embodiment, for a UE operating in a DL BWP of a cell where a full duplex UL sub-band is configured within a bandwidth of the DL BWP, the UE receives a CORESET configuration including frequency domain resource allocation information (e.g., the parameter “frequencyDomainResources”), and the UE identifies a plurality of RBs allocated for the CORESET from a set of [X]RB groups (e.g., X=6) within the DL BWP. The CORESET configuration includes information of at least one RB offset, with each respective RB offset of the at least one RB offset only applicable to a corresponding subset of consecutive [X]RB groups of the set of [X]RB groups. The UE identifies frequency location of a subset of consecutive [X]RB groups by applying a corresponding RB offset of the at least one RB offset to the corresponding subset of consecutive [X]RB groups.

In one implementation, a first RB offset indicates the RB level offset in units of RB from the first RB of the first [X]RB group to the first RB of BWP to determine the frequency domain resources of the corresponding first subset of consecutive [X]RB groups. A second RB offset indicates the RB offset in units of RB from the first RB of the first [X]RB group to the first RB of BWP to determine the frequency domain resources of the corresponding second subset of consecutive [X]RB groups. The grouping of [X]RB starts from the first RB group in the BWP.

In an implementation, a UE applies an RB offset specific to a subset of consecutive [X]RB groups for identifying CORESET resource allocation in frequency, if a PDCCH monitoring occasion associated with the CORESET of a DL BWP overlaps in time with a full duplex UL sub-band configured within a bandwidth of the DL BWP. Otherwise, the UE does not apply the RB offset specific to the subset of consecutive [X]RB groups. The UE may apply a common RB offset (e.g., first RB offset), if configured, to all the [X]RB groups

In another implementation, a UE first identifies frequency location of a set of [X]RB groups of a DL BWP by applying a first RB offset to the set of [X]RB groups, and then applies a second RB offset only to the frequency location of a subset of [X]RB groups.

A network entity determines a time and frequency resource for a full duplex UL sub-band and determines at least one RB offset for CORESET frequency resource allocation based on the time and frequency resource for the full duplex UL sub-band. Each of the at least one RB offset is specific to a corresponding subset of consecutive [X]RB groups of a set of [X]RB groups of a DL BWP.

In one implementation, if a CORESET is not associated with any search space set configured with “freqMonitorLocations”, of bits a bitmap “frequencyDomainResources” have a one-to-one mapping with non-overlapping groups of 6 consecutive physical resource blocks (PRBs), in ascending order of a PRB index in a DL BWP bandwidth of

$${N}_{RB}^{BWP} PRBs$$

with starting common RB position

$${N}_{BWP}^{start} ,$$

where the first common RB of the first group of 6 PRBs has common RB index

$$6 \cdot ⌈ {N}_{BWP}^{start} / 6 ⌉$$

if rb-Offset is not provided, or the first common RB of the first group of 6 PRBs has common RB index

$${N}_{BWP}^{start} + {N}_{RB}^{offset}$$

where

$${N}_{RB}^{offset}$$

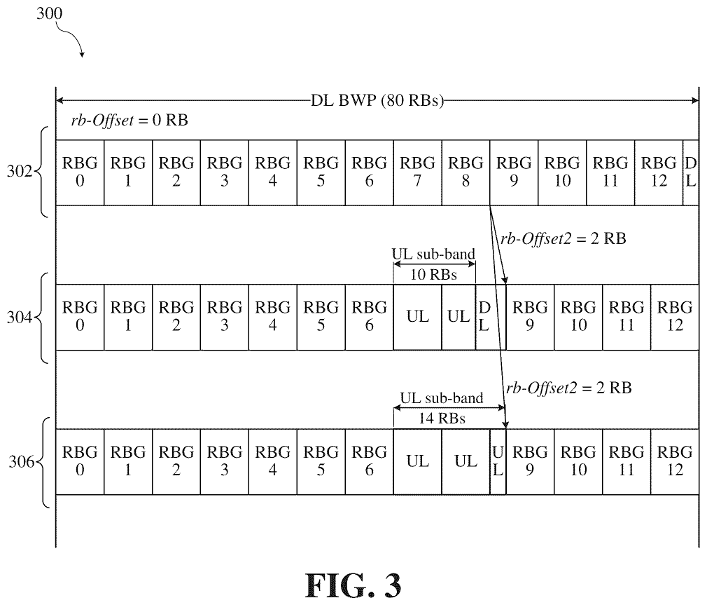

is provided by ro-Offset. Further, if rb-Offset2Info-r18 is configured as depicted in FIG. 3, the UE applies an additional RB level offset rb-Offset2-r18 to a subset of consecutive groups of 6 PRBs, where the first group of 6 PRBs of the subset of consecutive groups of 6 PRBs is identified by the parameter “rbg-Index-r18”. That is, if “rb-Offset” is not provided, the first common RB of the first group of 6 PRBs of the subset of consecutive groups of 6 PRBs has common RB index

$$6 \cdot ⌈ \frac{{N}_{BWP}^{start}}{6} ⌉ + 6 \cdot R + 0 ,$$

where R denotes a value of the parameter rbg-Index-r18 and 0 denotes a value of the parameter “rb-Offset2-r18”. If “rb-Offset” is provided, the first common RB of the first group of 6 PRBs of the subset of consecutive groups of 6 PRBs has common RB index

$${N}_{BWP}^{start} + {N}_{RB}^{offset} + 6 \cdot R + 0.$$

In another implementation, if a CORESET is associated with at least one search space set configured with “freqMonitorLocations”, the first

$${N}_{RBG , set 0}^{size}$$

bits of a bitmap “frequencyDomainResources” have a one-to-one mapping with non-overlapping groups of 6 consecutive PRBs, in ascending order of the PRB index in each RB set k in the DL BWP bandwidth of

$${N}_{RB}^{BWP} PRBs$$

with starting common RB position

$${RB}_{s 0 + k , DL}^{start , μ} ,$$

where the first common RB of the first group of 6 PRBs has common RB index

$${RB}_{s 0 + k , DL}^{start , μ} + {N}_{RB}^{offset}$$

and k is indicated by “freqMonitorLocations” if provided for a search space set. Otherwise, k=0. Further, if rb-Offset2Info-r18 is configured as shown in Example 1, the first common RB of the first group of 6 PRBs of a subset of consecutive groups of 6 PRBs identified by rbg-Index-r18 has common RB index

$${RB}_{s 0 + k , DL}^{start , μ} + {N}_{RB}^{offset} + 6 \cdot R + 0 ,$$

where R denotes a value of the parameter “rbg-Index-r18” and O denotes a value of the parameter “rb-Offset2-r18”.

$${N}_{RBG , set 0}^{size} = ⌊ ( {N}_{RB , set 0}^{size} - {N}_{RB}^{offset} ) / 6 ⌋ , {N}_{RB , set 0}^{size}$$

is a number of available PRBs in the RB set 0 for the DL BWP, and

$${N}_{RB}^{offset}$$

is provided by “rb-Offset” or

$${N}_{RB}^{offset} = 0$$

if “rb-Offset” is not provided. If a UE is provided RB sets in the DL BWP, the UE expects that the RBs of the CORESET are within the union of the PRBs in the RB sets of the DL BWP.

In one implementation, if a UE is configured with rb-Offset2-r18, the UE applies an additional RB level offset rb-Offset2-r18 to the second subset of consecutive groups of 6 PRBs. In one example, the second subset of consecutive groups of 6 PRBs is determined based on the bitmap frequencyDomainResources corresponding to the second group of consecutive bits set to 1 indicating the RB groups comprising the second subset of consecutive groups of 6 PRBs that belongs to the frequency domain resource of the CORESET. In another example, the first group of 6 PRBs of the second subset of consecutive groups of 6 PRBs is determined as the index of the group of 6 PRBs (based on grouping of 6 RB according to whether rb-Offset is provided) that is non-overlapping and occurs earliest following the UL sub-band and for which the bit in the bitmap frequencyDomainResources is set to 1.

In another embodiment, for a UE operating in a DL BWP of a cell where a full duplex UL sub-band is configured within a bandwidth of the DL BWP, the UE blindly decodes a set of PDCCH candidates on a configured PDCCH monitoring occasion, where each PDCCH candidate of the set of PDCCH candidates does not include any REG overlapping in time and frequency with the full duplex UL sub-band. Further, each PDCCH candidate of the set of PDCCH candidates does not include any REG overlapping in time and frequency with a guard band for the full duplex UL sub-band, if the guard band is configured or defined for the full duplex UL sub-band. Any PDCCH candidate including at least one REG overlapping in time and frequency with the full duplex UL sub-band is considered as an invalid PDCCH candidate, and the UE does not monitor the invalid PDCCH candidate and accordingly does not count the invalid PDCCH candidate for the number of monitored PDCCH candidates. In one implementation, the UE may implicitly or explicitly receive an indication of the full duplex UL sub-band, identify one or more invalid PDCCH candidates, overlapping in time and frequency with the full duplex UL sub-band, and skip decoding of the identified invalid PDCCH candidates.

In one implementation, REGs overlapping in time and frequency with the full duplex UL sub-band and/or guard band for the full duplex UL sub-band are not included in determining a REG bundle and the CCE-to-REG mapping. In another example, REGs overlapping in time and frequency with the full duplex UL sub-band and/or guard band are assumed to be punctured (e.g., DL RE set to value of 0). In another example, a REG bundle comprising at least one REG overlapping in time and frequency with the full duplex UL sub-band and/or guard band are assumed to be punctured. In another example, a REG bundle comprising at least one REG overlapping in time and frequency with the full duplex UL sub-band and/or guard band are not included in the CCE-to-REG mapping.

In an implementation, depending on (a) a duration of persistent overlap of a CORESET/SS (search space) with full duplex UL sub-band and/or (b) the number of overlapped/invalid PDCCH candidates and/or (c) the number of overlapped CCEs/REGs/RBs/Res, the UE uses the 1^{st} scheme (shifting control resources as described above or using an alternative CORESET) or the 2^{nd} scheme (discarding overlapped PDCCH candidates). For instance, if the UE is indicated that the full duplex UL sub-band is valid for ‘X’ time units, if ‘X’≥threshold, the 1^{st} scheme is used; otherwise, the 2^{nd} scheme is used. In another example, the UE is configured with a timer for a CORESET, and every time the CORESET/SS overlaps with the full duplex UL sub-band, the timer is decremented. while the timer is running, the UE uses the 2^{nd} scheme, and once the timer expires, the UE uses the first scheme (or in general uses an alternate search space/CORESET). The UE restarts the timer (a) every ‘X’ time units (‘X’ can be signaled/specified) (b) based on an indication from the network.

In an implementation, the UE is not required to monitor the PDCCH candidate overlapping with the full duplex UL sub-band when the UE does not monitor PDCCH candidates in a Type0-PDCCH CSS set.

In an implementation, the UE can be provided a set of RBs and symbols in a rate-matching pattern in PDCCH-Config or PUSCH-Config. For example, the UE is not expected to transmit UL transmission in the set of RBs and symbols associated with a full duplex DL sub-band and configured as the rate-matching pattern in the PUSCH-Config. Similarly, the UE is not expected to receive DL transmission in the set of RBs and symbols associated with the UL sub-band and configured as the rate-matching pattern in the PDCCH-Config. The full duplex UL/DL sub-band can be larger than the set of RBs and symbols configured as the rate-matching pattern.

In one implementation, a UE does not expect that a PDCCH monitoring occasion associated with CORESET0 of a cell overlaps with a time and frequency resource of a full duplex UL sub-band of the cell. In another implementation, a UE does not expect that a full duplex UL sub-band overlaps in frequency with any of a set of consecutive PRBs of CORESET0.

FIG. 3 presents exemplary six (6) RB group (RBG) configurations 300 for frequency domain resource allocation of a CORESET, when a full duplex UL sub-band is configured within a DL BWP for sub-band based full duplex operation. The first example 302 illustrates a grid of 6 RB groups for CORESET resource allocation with rb-Offset set to zero (or with rb-Offset not being configured). The second example 304 illustrates a grid of 6 RB groups with rb-Offset set to zero (or with rb-Offset not being configured) and rb-Offset2 of 2 RB being configured for the subset of RBGs comprising RBGs 9, 10, 11, and 12, when a full duplex UL sub-band of 10 RBs is configured. The third example 306 illustrates a grid of 6 RB groups with rb-Offset set to zero (or with rb-Offset not being configured) and rb-Offset2 of 2 RB being configured for the subset of RBGs comprising RBGs 9, 10, 11, and 12, when a full duplex UL sub-band of 14 RBs is configured.

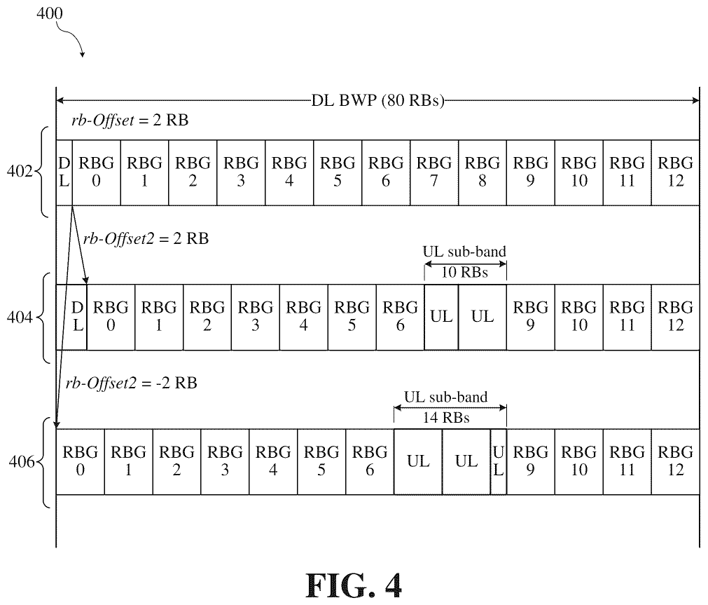

FIG. 4 presents another example six (6) RB group (RBG) configurations 400 for frequency domain resource allocation of a CORESET, when a full duplex UL sub-band is configured within a DL BWP for sub-band based full duplex operation. The first example 402 illustrates a grid of 6 RB groups for CORESET resource allocation with rb-Offset set to 2 RBs. The second example 404 illustrates a grid of 6 RB groups with rb-Offset set to 2 RBs and rb-Offset2 of 2 RBs being configured for the subset of RBGs comprising from RBG 0 up to RBG 6, when a full duplex UL sub-band of 10 RBs is configured. The third example 406 illustrates a grid of 6 RB groups with rb-Offset set to zero and rb-Offset2 of-2 RBs being configured for the subset of RBGs comprising from RBG 0 up to RBG 6, when a full duplex UL sub-band of 14 RBs is configured.

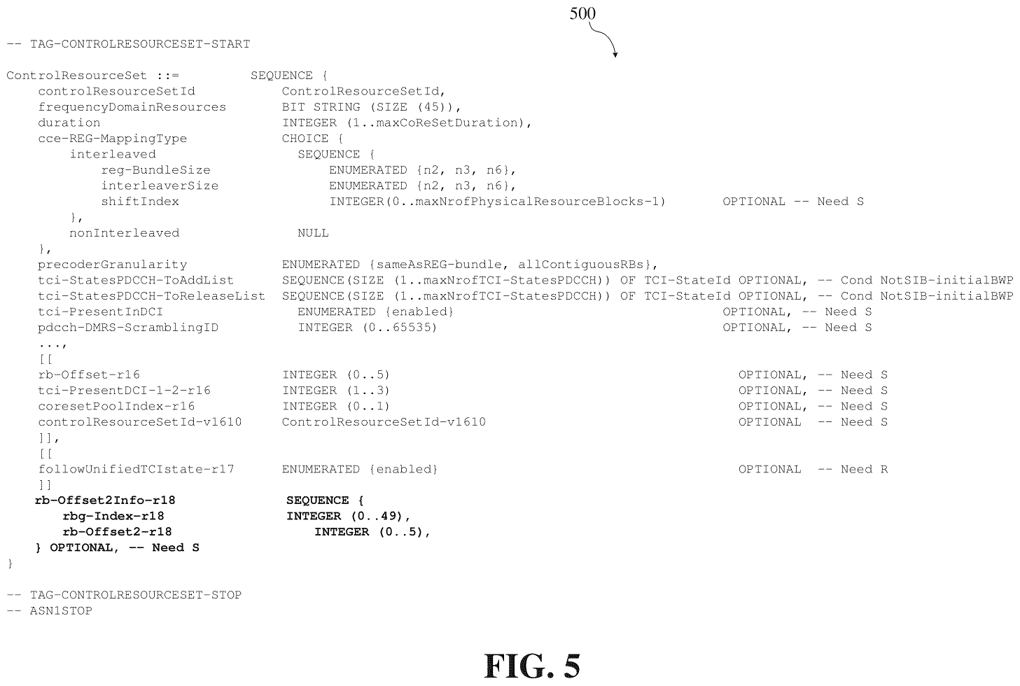

FIG. 5 depicts an example “ControlResourceSet” IE 500 that is used to configure a time/frequency control resource set (CORESET) in which to search for downlink control information. “Rb-Offset” indicates the RB level offset in units of RB from the first RB of the first 6 RB group to the first RB of BWP. “FrequencyDomainResources” indicates frequency domain resources for the CORESET. Each bit corresponds to a group of 6 RBs, with grouping starting from the first RB group in the BWP or multicast broadcast service (MBS) common frequency resource (CFR) where the CORESET is configured. When at least one search space is configured with freqMonitorLocation-r16, only the first

$${N}_{RBG , set 0}^{size}$$

bits are valid. The first (left-most/most significant) bit corresponds to the first RB group in the BWP or MBS CFR where the CORESET is configured, and so on. A bit that is set to 1 indicates that this RB group belongs to the frequency domain resource of this CORESET. Bits corresponding to a group of RBs not fully contained in the bandwidth part within which the CORESET is configured are set to zero. “Rbg-Index” indicates an index of the first 6 RB group among a subset of consecutive 6 RB groups for which the additional RB level offset, “rb-Offset2”, is applied. The 6 RB group index starts from 0. “Rb-Offset2” indicates the additional RB level offset in units of RB applied to the subset of consecutive 6 RB groups that starts from the 6 RB group indicated by the “rbg-Index”.

The present disclosure provides enhanced PDCCH resource allocation in symbols configured with full duplex sub-bands that a network entity would use for sub-band based full duplex operation, i.e., performing simultaneous reception and transmission in separate sub-bands within a carrier, where the separate sub-bands are non-overlapping or partially overlap in frequency. PDCCH resource allocation with sub-band based full duplex operation includes shifting of a subset of 6 PRB groups. A CORESET configuration includes at least one RB offset, each respective RB offset of the at least one RB offset only applicable to a corresponding subset of consecutive 6 PRB groups of a set of 6 PRB groups within a DL BWP. A UE identifies frequency location of a subset of consecutive 6 PRB groups by applying a corresponding RB offset of the at least one RB offset to the subset of consecutive 6 PRB groups. When a UE operates in a DL BWP, where a full duplex UL sub-band is configured within a bandwidth of the DL BWP, the UE excludes a PDCCH candidate that includes any REG overlapping in time and frequency with the full duplex UL sub-band from a search space set, and the UE does not decode the PDCCH candidate. By contrast, as currently implemented, an RB offset applicable to a set of 6 PRB groups of a DL BWP can be configured for CORESET resource allocation in frequency. However, one RB offset value specific to the entire set of 6 PRBs of the DL BWP may limit configuration flexibility for a bandwidth of a full duplex UL sub-band or lead to frequency resource fragmentation. The proposed PRB group shifting method, as presently disclosed, provides more freedom in frequency resource allocation of CORESET by applying different RB offset values to different subsets of 6 PRB groups and accordingly can support a flexible bandwidth configuration for a full duplex UL sub-band in a DL BWP, without compromising resource utilization efficiency.

According to aspects of the present disclosure, a method performed by a User Equipment (UE) includes receiving a control resource set (CORESET) configuration. The CORESET configuration includes information of at least one resource block (RB) offset. Each of the at least one RB offset is applicable to a respective corresponding subset of groups of first number of RBs of a set of groups of first number of RBs of a downlink (DL) bandwidth part (BWP). The method includes identifying a plurality of RBs allocated to the CORESET based on the CORESET configuration. The method includes receiving a physical downlink control channel (PDCCH) based on the plurality of RBs allocated to the CORESET.

In one or more embodiments, the first number is predefined. In one or more embodiments, the information of the at least one RB offset includes at least one RB offset value. In one or more particular embodiments, the information of the at least one RB offset further includes an indication of at least one subset of groups of first number of RBs corresponding to the at least one RB offset value.

In one or more embodiments, the at least one RB offset includes a first RB offset for a first subset of groups of first number of RBs. The method further includes receiving a second RB offset. The method includes identifying the plurality of RBs allocated to the CORESET by applying the second RB offset for the set of groups of first number of RBs and additionally applying the first RB offset for the first subset of groups of first number of RBs to determine a plurality of common RBs for the set of groups of first number of RBs.

In one or more embodiments, the method further includes receiving a full duplex UL sub-band configuration, including a full duplex UL sub-band. A bandwidth of the full duplex UL sub-band overlaps in frequency with a bandwidth of the DL BWP. In one or more particular embodiments, receiving the PDCCH includes performing blind decoding of a plurality of PDCCH candidates. Any of the plurality of PDCCH candidates do not overlap with a time and frequency resource of the full duplex UL sub-band. In one or more specific embodiments, each of the at least one RB offset is applied to a respective corresponding subset of groups of first number of RBs. A PDCCH monitoring occasion associated with the CORESET overlaps in time with the full duplex UL sub-band.

According to aspects of the present disclosure, a method performed by a Network Entity (NE) includes transmitting a control resource set (CORESET) configuration. The CORESET configuration includes information of at least one resource block (RB) offset. Each of the at least one RB offset is applicable to a respective corresponding subset of groups of first number of RBs of a set of groups of first number of RBs of a downlink (DL) bandwidth part (BWP). The method includes allocating a plurality of RBs to the CORESET based on the CORESET configuration. The method includes transmitting a physical downlink control channel (PDCCH) based on the plurality of RBs allocated to the CORESET.

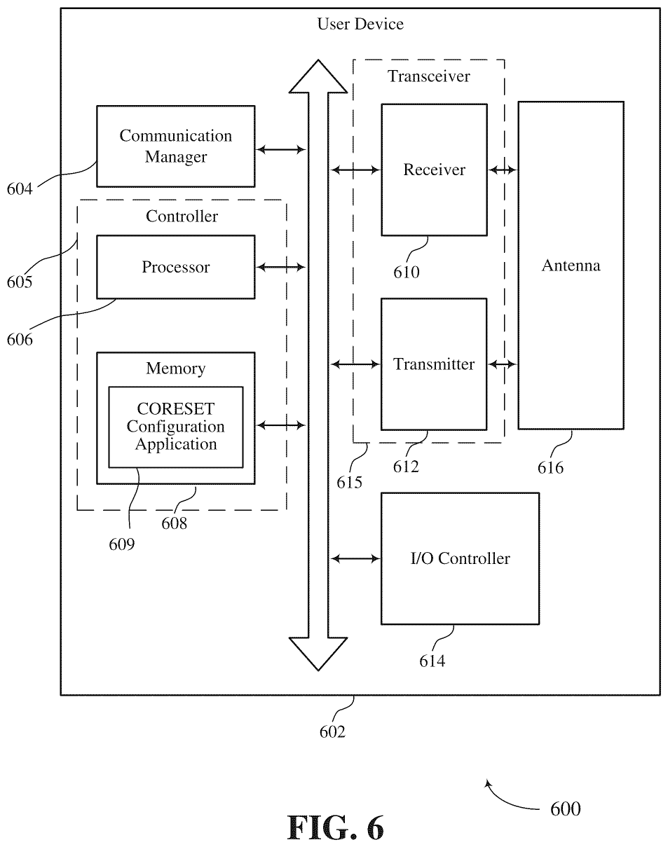

FIG. 6 illustrates an example of a block diagram 600 of a user device 602 that provides for wireless communication that supports PDCCH resource allocation for sub-band based full duplex operation, in accordance with aspects of the present disclosure. The user device 602 may be an example of a UE 104 as described herein. The user device 602 may support wireless communication with one or more base stations 102, UEs 104, or any combination thereof. The user device 602 may include components for bi-directional communications including components for transmitting and receiving communications, such as a communication manager 604, a controller 605 including a processor 606 and a memory 608, a transceiver including a receiver 610 and a transmitter 612, and an I/O controller 614. These components may be in electronic communication or otherwise coupled (e.g., operatively, communicatively, functionally, electronically, electrically) via one or more interfaces (e.g., buses). The receiver 610 and transmitter 612 may exist on a same chip and be collectively referred to as a transceiver 615.

The communication manager 604, the receiver 610, the transmitter 612, or various combinations thereof or various components thereof may be examples of means for performing various aspects of the present disclosure as described herein. For example, the communication manager 604, the controller 605/processor 606, the receiver 610, the transmitter 612, or various combinations or components thereof may support a method for performing one or more of the functions described herein. In an example, the processor 606 executes CORESET configuration application 609 that identifies a plurality of RBs allocated to the CORESET by applying each of at least one RB offset to a respective corresponding subset of 6 RB groups among a set of 6 RB groups of a DL BWP, and the processor configures the communication manager 604 to receive a PDCCH based on the plurality of RBs allocated to the CORESET.

In some implementations, the communication manager 604, the receiver 610, the transmitter 612, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 606 and the memory 608 coupled with the processor 606 as controller 605 may be configured to perform one or more of the functions described herein (e.g., by executing, by the processor 606, instructions stored in the memory 608). In an example, the processor 606 executes a CORESET configuration application 609 that configures the communication manager 604 to perform an enhanced decoding of a PDCCH in support of full duplex DL BWP communication.

Additionally, or alternatively, in some implementations, the communication manager 604, the receiver 610, the transmitter 612, or various combinations or components thereof may be implemented in code (e.g., as communications management software or firmware) executed by the processor 606. If implemented in code executed by the processor 606, the functions of the communication manager 604, the receiver 610, the transmitter 612, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communication manager 604 may be configured to perform various operations (e.g., receiving, monitoring, transmitting) using or otherwise in cooperation with the receiver 610, the transmitter 612, or both. For example, the communication manager 604 may receive information from the receiver 610, send information to the transmitter 612, or be integrated in combination with the receiver 610, the transmitter 612, or both to receive information, transmit information, or perform various other operations as described herein. Although the communication manager 604 is illustrated as a separate component, in some implementations, one or more functions described with reference to the communication manager 604 may be supported by or performed by the processor 606, the memory 608, or any combination thereof. For example, the memory 608 may store code, which may include instructions executable by the processor 606 to cause the user device 602 to perform various aspects of the present disclosure as described herein, or the processor 606 and the memory 608 may be otherwise configured to perform or support such operations.

The processor 606 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 606 may be configured to operate a memory array using a memory controller. In some other implementations, a memory controller may be integrated into the processor 606. The processor 606 may be configured to execute computer-readable instructions stored in a memory (e.g., the memory 608) to cause/configure the user device 602 to perform various functions of the present disclosure.

The memory 608 may include random access memory (RAM) and read-only memory (ROM). The memory 608 may store computer-readable, computer-executable code including instructions that, when executed by the processor 606 cause the user device 602 to perform various functions described herein. The code may be stored in a non-transitory computer-readable medium such as system memory or another type of memory. In some implementations, the code may not be directly executable by the processor 606 but may cause/configure a computer (e.g., when the code is compiled and executed) to perform functions described herein. In some implementations, the memory 608 may include, among other things, a basic I/O system (BIOS) which may control basic hardware or software operation such as the interaction with peripheral components or devices.

The I/O controller 614 may manage input and output signals for the user device 602. The I/O controller 614 may also manage peripherals not integrated into the user device 602. In some implementations, the I/O controller 614 may represent a physical connection or port to an external peripheral. In some implementations, the I/O controller 614 may utilize an operating system such as iOS®, ANDROID®, MS-DOS®, MS-WINDOWS®, OS/2®, UNIX®, LINUX®, or another known operating system. In some implementations, the I/O controller 614 may be implemented as part of a processor, such as the processor 606. In some implementations, a user may interact with the user device 602 via the I/O controller 614 or via hardware components controlled by the I/O controller 614.

In some implementations, the user device 602 may include a single antenna 616. However, in some other implementations, the user device 602 may have more than one antenna 616, which may be capable of concurrently transmitting or receiving multiple wireless transmissions. The receiver 610 and the transmitter 612 may communicate bi-directionally, via the one or more antennas 616, wired, or wireless links as described herein. For example, the receiver 610 and the transmitter 612 may represent a wireless transceiver and may communicate bi-directionally with another wireless transceiver. The transceiver may also include a modem to modulate the packets, to provide the modulated packets to one or more antennas 616 for transmission, and to demodulate packets received from the one or more antennas 616.

According to aspects of the present disclosure the user device 602 is provided for wireless communication. The user device 602 includes the transceiver 615 having at least one receiver 610 and at least one transmitter 612 that enable the user device 602 to communicate with a network entity, such as the base station 102 (FIG. 1). The controller 605 is communicatively coupled to the transceiver 615. The controller 605 receives, via the transceiver 615 of the user device 602, a CORESET configuration including information of at least one RB offset and of a plurality of RBs allocated to a CORESET. Each of the at least one RB offset corresponds to a respective subset of groups of a first number of RBs from among a larger set of groups of the first number of RBs of a DL BWP. The controller 605 configures the user device 602 to receive a PDCCH based on the plurality of RBs allocated to the CORESET. The controller 605 receives the PDCCH based on the plurality of RBs allocated to the CORESET.

In one or more embodiments, the information of the at least one RB offset includes at least one RB offset value. In one or more particular embodiments, the information of the at least one RB offset further includes an indication of at least one subset of groups of the first number of RBs corresponding to the at least one RB offset value.

In one or more embodiments, the at least one RB offset includes a first RB offset for a first subset of groups of the first number of RBs. The controller 605 receives a second RB offset. The controller 605 identifies the plurality of RBs allocated to the CORESET by: (i) applying the second RB offset for the set of groups of the first number of RBs; and (ii) applying the first RB offset for the first subset of groups of the first number of RBs to determine common RBs for the set of groups of the first number of RBs.

In one or more embodiments, the controller 605 receives a full duplex UL sub-band configuration including a full duplex UL sub-band. A bandwidth of the full duplex UL sub-band overlaps in frequency with a bandwidth of the DL BWP. In one or more particular embodiments, the controller 605 receives the PDCCH by performing blind decoding of a plurality of PDCCH candidates. None of the plurality of PDCCH candidates overlap with a time and frequency resource of the full duplex UL sub-band.

In one or more embodiments, each of the at least one RB offset is applied to a respective corresponding subset of groups of first number of RBs. A PDCCH monitoring occasion associated with the CORESET overlaps in time with the full duplex UL sub-band. In one or more embodiments, the controller 605 receives the CORSET configuration via RRC signaling. In one or more embodiments, the controller 605 identifies the plurality of RBs allocated to the CORESET based on the CORESET configuration.

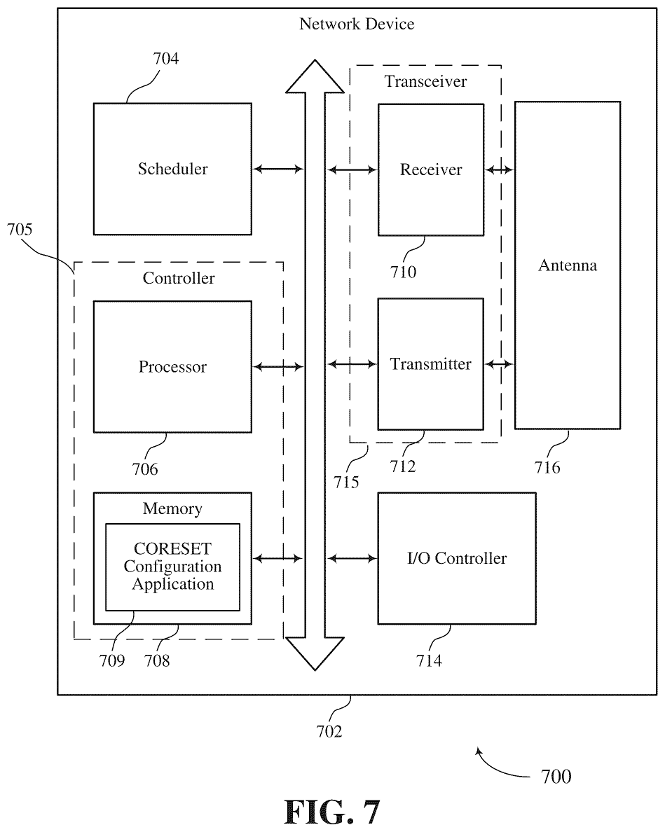

FIG. 7 illustrates an example of a block diagram 700 of a network device 702 that supports wireless communication that supports PDCCH resource allocation for sub-band based full duplex operation, in accordance with aspects of the present disclosure. The network device 702 may be an example of a base station 102 or a base node, as described herein. The network device 702 may support wireless communication with one or more base stations 102 and core network 106 as described in FIG. 1, UEs 104, or any combination thereof. The network device 702 may include components for bi-directional communications including components for transmitting and receiving communications, such as a scheduler 704, a processor 706, a memory 708, a receiver 710, transmitter 712, and an I/O controller 714. These components may be in electronic communication or otherwise coupled (e.g., operatively, communicatively, functionally, electronically, electrically) via one or more interfaces (e.g., buses). The processor 706 and memory 708 may be located on a single chip and collectively referred to as a controller 705. The receiver 710 and transmitter 712 may be located on a single chip and collectively referred to as a transceiver 715.

The scheduler 704, the receiver 710, the transmitter 712, or various combinations thereof or various components thereof may be examples of means for performing various aspects of the present disclosure as described herein. For example, the scheduler 704, the receiver 710, the transmitter 712, or various combinations or components thereof may support a method for performing one or more of the functions described herein.

In some implementations, the scheduler 704, the receiver 710, the transmitter 712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 706 and the memory 708 coupled with the processor 706 may be configured as a controller 705 to perform one or more of the functions described herein (e.g., by executing, by the processor 706, instructions stored in the memory 708).

Additionally, or alternatively, in some implementations, the scheduler 704, the receiver 710, the transmitter 712, or various combinations or components thereof may be implemented in code (e.g., as communications management software or firmware) executed by the processor 706. If implemented in code executed by the processor 706, the functions of the scheduler 704, the receiver 710, the transmitter 712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the scheduler 704 may be configured to perform various operations (e.g., receiving, monitoring, transmitting) using or otherwise in cooperation with the receiver 710, the transmitter 712, or both. For example, the scheduler 704 may receive information from the receiver 710, send information to the transmitter 712, or be integrated in combination with the receiver 710, the transmitter 712, or both to receive information, transmit information, or perform various other operations as described herein. Although the scheduler 704 is illustrated as a separate component, in some implementations, one or more functions described with reference to the scheduler 704 may be supported by or performed by the processor 706, the memory 708, or any combination thereof. For example, the memory 708 may store code, which may include instructions executable by the processor 706 to cause/configure the network device 702 to perform various aspects of the present disclosure as described herein, or the processor 706 and the memory 708 may be otherwise configured to perform or support such operations.

The processor 706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 706 may be configured to operate a memory array using a memory controller. In some other implementations, a memory controller may be integrated into the processor 706. The processor 706 may be configured to execute computer-readable instructions stored in a memory (e.g., the memory 708) to cause the network device 702 to perform various functions of the present disclosure. In an example, the processor 706 executes a CORESET configuration application 709 that configures the scheduler 704 to perform an enhanced resource allocation of a CORESET of a PDCCH in support of full duplex DL BWP communication. In addition, the scheduler 704 signals radio resource control information via the transceiver 715 to the user device 104 (FIG. 1) to successfully configure the CORESET of the PDCCH.

The memory 708 may include random access memory (RAM) and read-only memory (ROM). The memory 708 may store computer-readable, computer-executable code including instructions that, when executed by the processor 706 cause the network device 702 to perform various functions described herein. The code may be stored in a non-transitory computer-readable medium such as system memory or another type of memory. In some implementations, the code may not be directly executable by the processor 706 but may cause/configure a computer (e.g., when compiled and executed) to perform functions described herein. In some implementations, the memory 708 may include, among other things, a basic I/O system (BIOS) which may control basic hardware or software operation such as the interaction with peripheral components or devices.

The I/O controller 714 may manage input and output signals for the network device 702. The I/O controller 714 may also manage peripherals not integrated into the network device 702. In some implementations, the I/O controller 714 may represent a physical connection or port to an external peripheral. In some implementations, the I/O controller 714 may utilize an operating system such as iOS®, ANDROID®, MS-DOS®, MS-WINDOWS®, OS/2®, UNIX®, LINUX®, or another known operating system. In some implementations, the I/O controller 714 may be implemented as part of a processor, such as the processor 706. In some implementations, a user may interact with the network device 702 via the I/O controller 714 or via hardware components controlled by the I/O controller 714.

In some implementations, the network device 702 may include a single antenna 716. However, in some other implementations, the network device 702 may have more than one antenna 716, which may be capable of concurrently transmitting or receiving multiple wireless transmissions. The receiver 710 and the transmitter 712 may communicate bi-directionally, via the one or more antennas 716, wired, or wireless links as described herein. For example, the receiver 710 and the transmitter 712 may represent a wireless transceiver and may communicate bi-directionally with another wireless transceiver. The transceiver may also include a modem to modulate the packets, to provide the modulated packets to one or more antennas 716 for transmission, and to demodulate packets received from the one or more antennas 716.

According to one or more aspects of the present disclosure, the scheduler 704 may support wireless communication at a first network device (e.g., the network device 702) in accordance with examples as disclosed herein. The network device 702 includes the transceiver 715 including at least one receiver 710 and at least one transmitter 712 that enable the network device 702 to communicate with a user device such as UE 104 (FIG. 1). The controller 705 is communicatively coupled to the transceiver 715. According to aspects of the present disclosure, the controller 705 transmits a CORESET configuration including information of at least one RB offset. Each of the at least one RB offset corresponds to a respective subset of groups of first number of RBs of a set of groups of first number of RBs of a DL BWP. The controller 705 allocates a plurality of RBs to the CORESET based on the CORESET configuration. The controller 705 transmits a physical downlink control channel (PDCCH) based on the plurality of RBs allocated to the CORESET according to the at least one RB offset.

In one or more embodiments, the information of the at least one RB offset includes at least one RB offset value. In one or more particular embodiments, the information of the at least one RB offset further includes an indication of at least one subset of groups of the first number of RBs corresponding to the at least one RB offset value.

In one or more embodiments, the at least one RB offset includes a first RB offset for a first subset of groups of first number of RBs. The controller 705 transmits a second RB offset. The plurality of RBs allocated to the CORESET is determined based on: (i) the second RB offset being applied to the set of groups of first number of RBs; and (ii) the first RB offset being applied to the first subset of groups of first number of RBs to identify common RBs for the set of groups of first number of RBs.

In one or more embodiments, the controller 705 transmits a full duplex UL sub-band configuration including a full duplex UL sub-band. A bandwidth of the full duplex UL sub-band overlaps in frequency with a bandwidth of the DL BWP. In one or more particular embodiments, the controller 705 transmits the PDCCH by using a PDCCH candidate of a plurality of PDCCH candidates. None of the plurality of PDCCH candidates overlap with a time and frequency resource of the full duplex UL sub-band.

In one or more embodiments, each of the at least one RB offset is applied to a respective corresponding subset of groups of first number of RBs. A PDCCH monitoring occasion associated with the CORESET overlaps in time with the full duplex UL sub-band. In one or more embodiments, the controller 705 transmits the CORSET configuration via RRC signaling. In one or more embodiments, the controller 705 sets CORESET configuration parameters based on the plurality of RBs allocated to the CORESET.

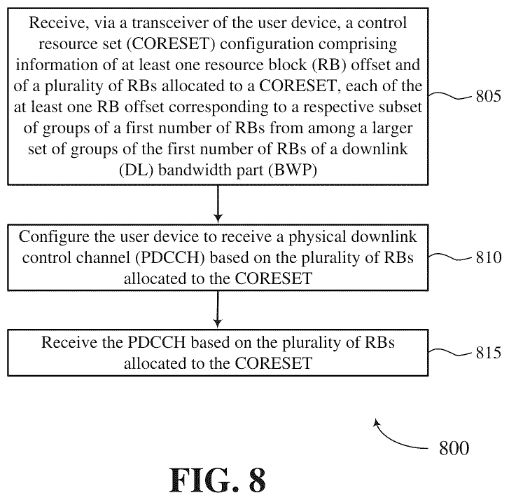

FIG. 8 illustrates a flowchart of a method 800 performed by a user device that supports wireless communication with a network device, for resource allocation in symbols configured with full duplex sub-bands used for sub-band based full duplex operation, in accordance with aspects of the present disclosure. The operations of the method 800 may be implemented by a user device or its components as described herein. For example, the operations of the method 800 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 805, the method 800 may include receiving, via a transceiver of the user device, a control resource set (CORESET) configuration comprising information of at least one resource block (RB) offset and of a plurality of RBs allocated to a CORESET. Each of the at least one RB offset corresponds to a respective subset of groups of a first number of RBs from among a larger set of groups of the first number of RBs of a downlink (DL) bandwidth part (BWP). The operations of 805 may be performed in accordance with examples as described herein. In some implementations, aspects of the operations of 805 may be performed by a device as described with reference to FIG. 1 or 6.

At 810, the method 800 may include configuring the user device to receive a physical downlink control channel (PDCCH) based on the plurality of RBs allocated to the CORESET. The operations of 810 may be performed in accordance with examples as described herein. In some implementations, aspects of the operations of 810 may be performed by a device as described with reference to FIG. 1 or 6.

At 815, the method 800 may include receiving the PDCCH based on the plurality of RBs allocated to the CORESET. The operations of 815 may be performed in accordance with examples as described herein. In some implementations, aspects of the operations of 815 may be performed by a device as described with reference to FIG. 1 or 6.

In one or more embodiments, the information of the at least one RB offset comprises at least one RB offset value. In one or more particular embodiments, the information of the at least one RB offset further comprises an indication of at least one subset of groups of the first number of RBs corresponding to the at least one RB offset value.

In one or more embodiments, the at least one RB offset comprises a first RB offset for a first subset of groups of the first number of RBs. The method 800 may include receiving a second RB offset. The method 800 may include identifying the plurality of RBs allocated to the CORESET by: (i) applying the second RB offset for the set of groups of the first number of RBs; and (ii) applying the first RB offset for the first subset of groups of the first number of RBs to determine common RBs for the set of groups of the first number of RBs.

In one or more embodiments, the method 800 includes receiving a full duplex uplink (UL) sub-band configuration including a full duplex UL sub-band, where a bandwidth of the full duplex UL sub-band overlaps in frequency with a bandwidth of the DL BWP. In one or more particular embodiments, the method 800 includes receiving the PDCCH that comprises performing blind decoding of a plurality of PDCCH candidates, where none of the plurality of PDCCH candidates overlap with a time and frequency resource of the full duplex UL sub-band. In one or more particular embodiments, each of the at least one RB offset is applied to a respective corresponding subset of groups of first number of RBs, when a PDCCH monitoring occasion associated with the CORESET overlaps in time with the full duplex UL sub-band.

In one or more embodiments, the method 800 includes receiving the CORSET configuration via radio resource control (RRC) signaling. In one or more embodiments, the method 800 includes identifying the plurality of RBs allocated to the CORESET based on the CORESET configuration.

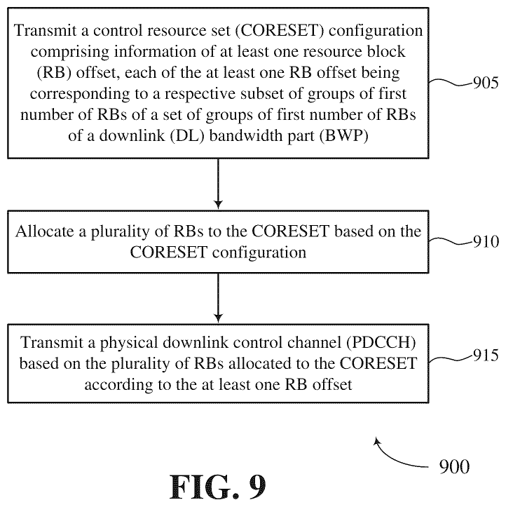

FIG. 9 illustrates a flowchart of a method 900, by a network device that supports wireless communication with a user device, for resource allocation in symbols configured with full duplex sub-bands used for sub-band based full duplex operation, in accordance with aspects of the present disclosure. The operations of the method 900 may be implemented by a device or its components as described herein. For example, the operations of the method 900 may be performed by a network device, base node, or base station 102 as described with reference to FIGS. 1 through 7. In some implementations, the network device may execute a set of instructions to control the function elements of the network device to perform the described functions. Additionally, or alternatively, the network device may perform aspects of the described functions using special-purpose hardware.

At 905, the method may include transmitting a CORESET configuration comprising information of at least one RB offset, each of the at least one RB offset corresponding to a respective subset of groups of first number of RBs of a set of groups of first number of RBs of a DL BWP. The operations of 905 may be performed in accordance with examples as described herein. In some implementations, aspects of the operations of 905 may be performed by a device as described with reference to FIG. 1 or 7.

At 910, the method may include allocating a plurality of RBs to the CORESET, based on the CORESET configuration. The operations of 910 may be performed in accordance with examples as described herein. In some implementations, aspects of the operations of 910 may be performed by a device as described with reference to FIG. 1 or 7.

At 915, the method may include transmitting a physical downlink control channel (PDCCH) based on the plurality of RBs allocated to the CORESET according to the at least one RB offset. The operations of 915 may be performed in accordance with examples as described herein. In some implementations, aspects of the operations of 915 may be performed by a device as described with reference to FIG. 1 or 7.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, the UE comprising:
a memory; and
a processor communicatively coupled to the memory and configured to cause the UE to:
receive a control resource set (CORESET) configuration comprising information of at least one resource block (RB) offset and of a plurality of RBs allocated to a CORESET, each of the at least one RB offset corresponding to a respective subset of groups of a first number of RBs from among a larger set of groups of the first number of RBs of a downlink (DL) bandwidth part (BWP);
configure the UE to receive a physical downlink control channel (PDCCH) based on the plurality of RBs allocated to the CORESET; and
receive the PDCCH based on the plurality of RBs allocated to the CORESET.

2. The UE of claim 1, wherein the information of the at least one RB offset comprises at least one RB offset value and an indication of at least one subset of groups of the first number of RBs corresponding to the at least one RB offset value.

3. The UE of claim 1, wherein the at least one RB offset comprises a first RB offset for a first subset of groups of the first number of RBs, and the processor is further configured to cause the UE to:
receive a second RB offset; and
identify the plurality of RBs allocated to the CORESET by: (i) applying the second RB offset for the set of groups of the first number of RBs; and (ii) applying the first RB offset for the first subset of groups of the first number of RBs to determine common RBs for the set of groups of the first number of RBs.

4. The UE of claim 1, wherein the controller receives a full duplex uplink (UL) sub-band configuration including a full duplex UL sub-band, wherein a bandwidth of the full duplex UL sub-band overlaps in frequency with a bandwidth of the DL BWP.

5. The UE of claim 4, wherein the processor is further configured to cause the UE to receive the PDCCH by performing blind decoding of a plurality of PDCCH candidates, wherein none of the plurality of PDCCH candidates overlap with a time and frequency resource of the full duplex UL sub-band.

6. The UE of claim 4, wherein each of the at least one RB offset is applied to a respective corresponding subset of groups of first number of RBs, when a PDCCH monitoring occasion associated with the CORESET overlaps in time with the full duplex UL sub-band.

7. The UE of claim 1, wherein the controller processor is further configured to cause the UE to: receive the CORSET configuration via radio resource control (RRC) signaling; and identify the plurality of RBs allocated to the CORESET based on the CORESET configuration.

8. A controller for wireless communication by a user equipment (UE), the controller comprising:
at least one processor coupled with at least one memory and configured to cause the controller to:
receive a control resource set (CORESET) configuration comprising information of at least one resource block (RB) offset and of a plurality of RBs allocated to a CORESET, each of the at least one RB offset corresponding to a respective subset of groups of a first number of RBs from among a larger set of groups of the first number of RBs of a downlink (DL) bandwidth part (BWP);
configure the UE to receive a physical downlink control channel (PDCCH) based on the plurality of RBs allocated to the CORESET; and
receive the PDCCH based on the plurality of RBs allocated to the CORESET.

9. The controller of claim 8, wherein the information of the at least one RB offset comprises at least one RB offset value and an indication of at least one subset of groups of the first number of RBs corresponding to the at least one RB offset value.

10. The controller of claim 8, wherein the at least one RB offset comprises a first RB offset for a first subset of groups of the first number of RBs, and processor further causes the controller to:
receive a second RB offset; and
identify the plurality of RBs allocated to the CORESET by: (i) applying the second RB offset for the set of groups of the first number of RBs; and (ii) applying the first RB offset for the first subset of groups of the first number of RBs to determine common RBs for the set of groups of the first number of RBs.

11. The controller of claim 8, wherein the processor receives a full duplex uplink (UL) sub-band configuration including a full duplex UL sub-band, wherein a bandwidth of the full duplex UL sub-band overlaps in frequency with a bandwidth of the DL BWP.

12. The controller of claim 11, wherein the processor receives the PDCCH by performing blind decoding of a plurality of PDCCH candidates, wherein none of the plurality of PDCCH candidates overlap with a time and frequency resource of the full duplex UL sub-band.

13. The controller of claim 11, wherein each of the at least one RB offset is applied to a respective corresponding subset of groups of first number of RBs, when a PDCCH monitoring occasion associated with the CORESET overlaps in time with the full duplex UL sub-band.

14. A method performed by a user equipment (UE), the method comprising:
receiving a control resource set (CORESET) configuration comprising information of at least one resource block (RB) offset and of a plurality of RBs allocated to a CORESET, each of the at least one RB offset corresponding to a respective subset of groups of a first number of RBs from among a larger set of groups of the first number of RBs of a downlink (DL) bandwidth part (BWP);
configuring the UE to receive a physical downlink control channel (PDCCH) based on the plurality of RBs allocated to the CORESET; and
receiving the PDCCH based on the plurality of RBs allocated to the CORESET.

15. The method of claim 14, wherein the information of the at least one RB offset comprises at least one RB offset value and an indication of at least one subset of groups of the first number of RBs corresponding to the at least one RB offset value.

16. The method of claim 14, wherein the at least one RB offset comprises a first RB offset for a first subset of groups of the first number of RBs, the method further comprising:
receiving a second RB offset; and
identifying the plurality of RBs allocated to the CORESET by: (i) applying the second RB offset for the set of groups of the first number of RBs; and (ii) applying the first RB offset for the first subset of groups of the first number of RBs to determine common RBs for the set of groups of the first number of RBs.

17. The method of claim 14, further comprising receiving a full duplex uplink (UL) sub-band configuration including a full duplex UL sub-band, wherein a bandwidth of the full duplex UL sub-band overlaps in frequency with a bandwidth of the DL BWP.

18. The method of claim 17, wherein receiving the PDCCH comprises performing blind decoding of a plurality of PDCCH candidates, wherein none of the plurality of PDCCH candidates overlap with a time and frequency resource of the full duplex UL sub-band.

19. The method of claim 17, wherein each of the at least one RB offset is applied to a respective corresponding subset of groups of first number of RBs, when a PDCCH monitoring occasion associated with the CORESET overlaps in time with the full duplex UL sub-band.

20. A base station for wireless communication, the base station comprising:
a memory; and
a processor communicatively coupled to the memory and configured to cause the base station to:
transmit a control resource set (CORESET) configuration comprising information of at least one resource block (RB) offset, each of the at least one RB offset being corresponding to a respective subset of groups of first number of RBs of a set of groups of first number of RBs of a downlink (DL) bandwidth part (BWP);
allocate a plurality of RBs to the CORESET based on the CORESET configuration; and
transmit a physical downlink control channel (PDCCH) based on the plurality of RBs allocated to the CORESET according to the at least one RB offset.
